(19) United States
(12) Patent Application Publication
(10) Pub. No.: US 2020/0293072 A1
(43) Pub. Date: Sep. 17, 2020

(54) HOSE FITTING WITH FREEZE PROTECTION VALVE AND METHOD

(71) Applicant: Levan Ly, Sugar Land, TX (US)

(72) Inventor: Levan Ly, Sugar Land, TX (US)

(21) Appl. No.: 16/454,574

(22) Filed: Jun. 27, 2019

Related U.S. Application Data
(60) Provisional application No. 62/818,033, filed on Mar. 13, 2019.

(51) Int. Cl. G05D 23/19; F16L 41/02; F16L 15/00

(52) U.S. Cl. CPC G05D 23/1919; G05D 23/1902; F16L 15/006; F16L 41/023

(57) ABSTRACT

A flow-regulating device is able to automatically prevent freezing of water within conduits. The flow-regulating device includes a water-tight manifold, a normally-closed flow-valve, a solenoid able to open the flow-valve, a thermal-sensor, and an electronic circuit. The manifold has a threaded hose-outlet, a drain-outlet, and an inlet. The flow-valve enables fluid to flow between the inlet and the drain-outlet when opened by the solenoid. The thermal-sensor produces a temperature-signal corresponding to an exterior-temperature and transmits the temperature-signal to the electronic circuit. The electronic-circuit produces a flow-signal based upon the temperature-signal when the temperature-signal drops below a temperature-threshold, and transmits the flow-signal to the solenoid, thereby opening the flow-valve when the exterior-temperature drops below a predetermined threshold. In this way, the system can be configured to automatically enable fluid flow through the device and associated conduit when the exterior-temperature drops below freezing, reducing the likelihood of pipes freezing during the winter.

### CROSS-REFERENCE TO RELATED APPLICATION(S)

The present application is related to and claims priority to U.S. Provisional Patent Application No. 62/818,033 filed Mar. 13, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of plumbing of existing art and more specifically relates to valve control systems.

### RELATED ART

Plumbing systems in colder climates are at constant risk of critical damage. When outdoor temperatures drop, there is a risk of water freezing and expanding within the conduits and causing the pipes to burst. A burst water pipe can create subsequent problems beyond the initial damage to the plumbing system, such as water damage to insulation, drywall, flooring, furniture, appliances, and more. This damage can be extremely costly to repair. In addition, the water damage can result in mold and mildew growth. Many individuals will intentionally leave exterior water valves slightly open in order to induce a constant stream of water to prevent freezing. However, this is unnecessarily wasteful, and require constant thought and attention from a homeowner to turn the valve on when temperatures demand it. A suitable solution is desired.

U.S. Pat. No. 4,672,990 to Fred W. Robillard relates to a system for freeze protection of pipes. The described system for freeze protection of pipes includes a system for freeze protection of pipes is provided, comprising a cold water supply line, connected to a main water supply line at one end and to at least one cold water fixture at the other end; a hot water tank having an inlet and an outlet; a hot water tank inlet line, connected at one end to the cold water supply line, and at the other end to the hot water tank inlet; a hot water supply line, connected to the hot water tank outlet at one end and to at least one hot water fixture at the other end; at least one restrictive connection, connecting between the cold water supply line and the hot water supply line; and a circulating pump, connected in-line in a circuit comprising the cold water supply line, the hot water tank inlet line, the hot water tank, the hot water supply line and the restrictive connection.

### SUMMARY OF THE INVENTION

In view of the foregoing disadvantages inherent in the known valve control art, the present disclosure provides a novel hose fitting with freeze protection valve and method. The general purpose of the present disclosure, which will be described subsequently in greater detail, is to provide a hose fitting with freeze protection valve and method.

A flow-regulating device is disclosed herein. The flow-regulating device is able to automatically prevent freezing of water within conduits. The flow-regulating device includes a water-tight manifold, a normally-closed flow-valve, a solenoid able to open the flow-valve, a thermal-sensor, and an electronic circuit. The manifold has a threaded hose-outlet, a drain-outlet, and an inlet. The flow-valve enables fluid to flow between the inlet and the drain-outlet when opened by the solenoid. The thermal-sensor produces a temperature-signal corresponding to an exterior-temperature and transmits the temperature-signal to the electronic circuit. The electronic-circuit produces a flow-signal based upon the temperature-signal when the temperature-signal drops below a temperature-threshold, and transmits the flow-signal to the solenoid, thereby opening the flow-valve when the exterior-temperature drops below a predetermined threshold. In this way, the system can be configured to automatically enable fluid flow through the device and associated conduit when the exterior-temperature drops below freezing, reducing the likelihood of pipes freezing during the winter.

According to another embodiment, a method of preventing a water conduit from freezing in cold temperatures is also disclosed herein. The method of preventing a water conduit from freezing in cold temperatures includes providing the above-described flow-regulating device; coupling the inlet with a conduit; coupling the electronic-circuit to a power source; generating the temperature signal via the thermal-sensor; transmitting the temperature-signal to the electronic-circuit; converting the temperature-signal to a flow-signal when the temperature-signal drops below a temperature-threshold; transmitting the flow-signal to the solenoid; activating the solenoid to open the flow-valve, thereby enabling a flow of fluid through the drain-outlet; and optionally, coupling the hose-outlet to a garden hose.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a hose fitting with freeze protection valve and method, constructed and operative according to the teachings of the present disclosure.

FIG. 1 is a perspective view of the flow-regulating device during an ‘in-use’ condition, according to an embodiment of the disclosure.

FIG. 2 is a perspective view of the flow-regulating device of FIG. 1, according to an embodiment of the present disclosure.

FIG. 3 is a perspective view of the display of the flow-regulating device of FIG. 1, according to an embodiment of the present disclosure.

FIG. 4 is a flow diagram illustrating a method of use for preventing pipes from freezing, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a discharge control system and more particularly to a hose fitting with freeze protection valve and method as used to improve the preventing pipes from freezing.

Generally, the flow-regulating device is a system that alleviates freezing problems by allowing flow through a discharge valve when the ambient temperature of the environment falls below a predetermined threshold. Because allowing the water within the conduit increases the kinetic energy of the water, the water is less likely to freeze. Additionally, because new water is continually being drawn from parts of the system more insulated than the location of the device, the water flowing through the system and out the discharge has less time to cool and freeze. The flow-regulating device further provides an automated system for protecting pipes from freezing during cold weather. The system selectively opens a discharge valve to allow a slow drip of water to flow when exterior temperatures reach a preset range, thereby preventing a pipe from bursting and causing costly water damage to an occupied structure, such as a home or business. In this way, the system eliminates damage to the plumbing system, insulation, sheetrock, flooring, furniture, and more, offering a system that is low cost, easy to install and maintain, and can be operated using very low levels of electricity consumption.

The flow-regulating device is able to be installed on the exterior of a home or building to prevent pipes from freezing during temperature changes. In particular, the device may be advantageous for protecting exterior pipes which feed garden hoses. Preferably, the device is a tee or splitter fitting which has an inlet and two outlets. One outlet of the device includes a threaded adapter sized to receive a garden hose. The other outlet includes an electronic solenoid that controls a flow valve, and a drain on the terminal side of the flow valve. In some embodiments, this drain could be connected to another conduit, but in most application, the drain may simply terminate in an aperture, allowing the water passing through the flow valve to drain to the environment. The system includes a sensor and associated circuitry which can recognize the temperature outdoors and cause the solenoid in response to release a slow flow of water. The system may be powered using a household type transformer which reduces a one-hundred-and-ten volt input to a twelve-volt output, in order to supply low voltage power to an electronic circuit board with a display temperature screen and the thermal sensor probe. For the purposes of this specification, “one-hundred-and-ten volt” and “twelve-volt” are not understood to be exact figures, but rather, the electrical standards for electrical devices operating within allowable voltage ranges which are expressed by those having skill in the art as “one-hundred-and-ten volt” and “twelve-volt” respectively. The device can be installed on either a hose bib water outlet or on water supply inlet side with manual override button. The device is serviceable and can be checked and tested for proper functionality at any given time of the year. The exact specifications may vary.

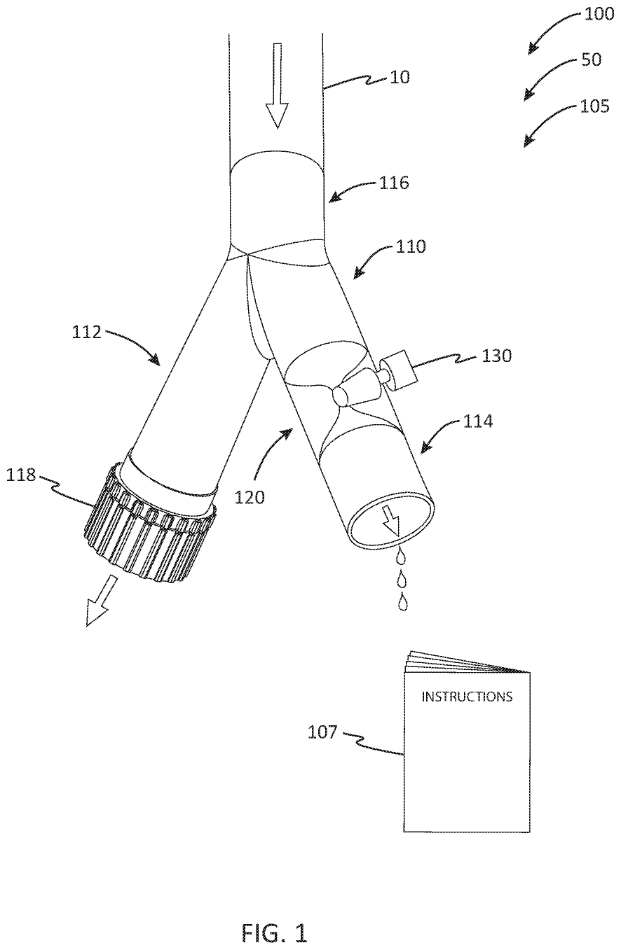

Referring now more specifically to the drawings by numerals of reference, there is shown in FIGS. 1-4, various views of a flow-regulating device 100.

FIG. 1 shows a flow-regulating device during an ‘in-use’ condition 50, according to an embodiment of the present disclosure. Here, the flow-regulating device may be beneficial for use to prevent a water conduit from freezing in cold temperatures. Flow-regulating device 100 may be able to automatically prevent freezing of water within conduit 10. Flow-regulating device 100 may include water-tight manifold 110. Water-tight manifold 110 may itself have hose-outlet 112 which terminates in threaded-adapter 118, drain-outlet 114, inlet 116. Threaded adapter 118 is preferably a ¾ inch-11.5 garden hose thread (GHT). However, in some embodiments, other application-appropriate thread sizes may be used. Inlet 116 may be in fluid communication with at least hose-outlet 112, and inlet 116 able to be fluidly connected with conduit 10. Inlet 116 may be threaded in some embodiments in order to mechanically couple with 10. Alternatively, inlet 116 may be flared or have other mechanical coupling features and devices. Hose-outlet 112 may always be in fluid communication with inlet 116 in some embodiments. Alternatively, addition valves (such as a manual flow valve) may be disposed between inlet 116 and hose-outlet 116. Normally-closed flow-valve 120 enables fluid communication between inlet 116 and drain-outlet 114 when not closed. Solenoid 130 may be mounted to flow-valve 120 and is able to open flow-valve 120 when engaged. Each of the inlet, the hose-outlet, and the drain-outlet may be substantially tubular, and may be constructed of cast iron, steel, plastic, aluminum, or other suitably rigid and environmentally resistant materials.

According to one embodiment, the flow-regulating device 100 may be arranged as a kit 105. In particular, the flow-regulating device 100 may further include a set of instructions 107. The instructions 107 may detail functional relationships in relation to the structure of the flow-regulating device 100 such that the flow-regulating device 100 can be used, maintained, or the like, in a preferred manner.

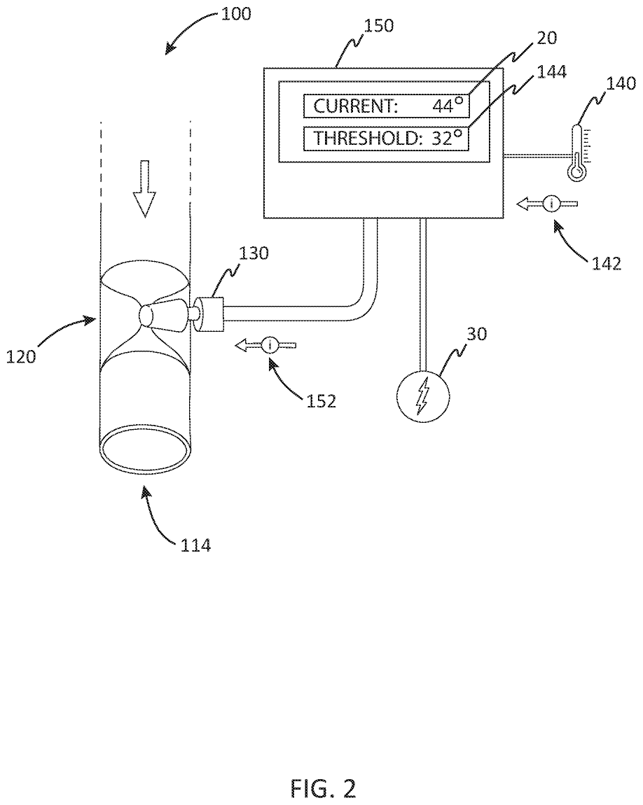

FIG. 2 shows the flow-regulating device 100 of FIG. 1, according to an embodiment of the present disclosure. As above, the flow-regulating device 100 may include flow-valve 120 and solenoid 130 which selectively operates flow-valve 120. Thermal-sensor 140 may be able to produce temperature-signal 142 corresponding to exterior-temperature 20. Temperature-signal 142 may be linearly scaled and proportional to exterior-temperature 20 is some embodiments. Each potential value of temperature-signal 142 corresponds to a value of exterior-temperature 20. Electronic-circuit 150 may able to accept power from power-source 30, receive temperature-signal 142 from thermal-sensor 140, and produce flow-signal 152 based upon temperature-signal 142 when temperature-signal 142 drops below temperature-threshold 144. Temperature-threshold 144 may be between thirty-one and thirty-three degrees Fahrenheit. Solenoid 130 may be responsive to open when solenoid 130 receives flow-signal 152 from electronic-circuit 150. In this way, flow-regulating device 100 as a whole is able to change a position of flow-valve 120 in response to exterior-temperature 20 in order to create fluid flow from inlet 116 (FIG. 1) to drain-outlet 114 as exterior-temperature 20 decreases to undesirably low values.

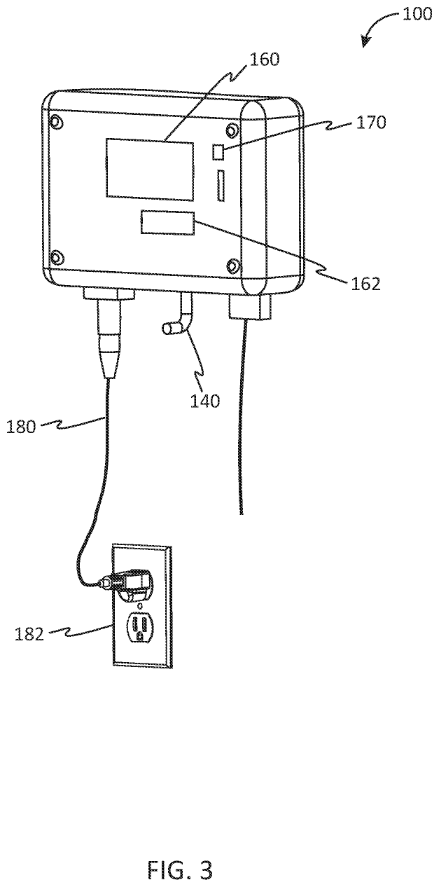

FIG. 3 is a perspective view of the display of the flow-regulating device of FIG. 1, according to an embodiment of the present disclosure. Flow-regulating device 100 may also include temperature-display screen 160, which is able to indicate a temperature as determined by thermal-sensor 140. A transformer-adapter 180 may be is able to accept power from a power-source and provide a twelve-volt power signal output to flow-regulating device 100. Flow-regulating device 100 may also include manual-override button 170, which may be in electrical communication with a power source and with solenoid 130 (FIG. 1), such that engaging manual-override button 170 engages solenoid 130 (FIG. 1) by connection it with the power source, thereby opening normally-closed flow-valve 120 (FIG. 1). Transformer-adapter 180 may comprise power-input adapter 182. Power-input adapter 182 may be either a NEMA-1 standard plug and a NEMA-5 standard plug. Temperature-threshold 144 (FIG. 2) may be user-programmable via user-interface 162, with user-interface 162 being in digital communication with electronic-circuit 150 (FIG. 2).

Upon reading this specification, it should be appreciated that, under appropriate circumstances, considering such issues as user preferences, design preference, structural requirements, marketing preferences, cost, available materials, technological advances, etc., other structural arrangements such as, for example, additional fasteners, mounts, features, circuits, etc., may be sufficient.

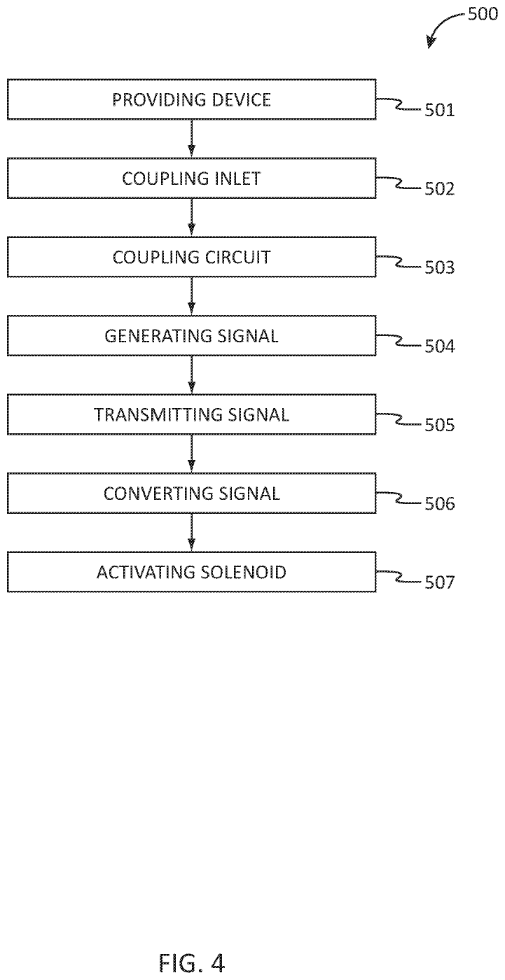

FIG. 4 is a flow diagram illustrating a method for preventing pipes from freezing, according to an embodiment of the present disclosure. In particular, the method for preventing pipes from freezing 500 may include one or more components or features of the flow-regulating device 100 as described above. As illustrated, the method for preventing pipes from freezing 500 may include the steps of: step one 501, providing a flow-regulating device able to automatically prevent freezing of water within conduits, the flow-regulating device comprising a water-tight manifold having a hose-outlet comprising a threaded-adapter, a drain-outlet, and an inlet in fluid communication with at least the hose-outlet, the inlet able to be fluidly connected with a conduit; a normally-closed flow-valve which, when not closed, enables fluid communication between the inlet and the drain-outlet, a solenoid able to open the flow-valve when engaged, a thermal-sensor able to produce a temperature-signal corresponding to an exterior-temperature, an electronic-circuit able to accept power from a power-source, receive the temperature-signal from the thermal-sensor, and produce a flow-signal based upon the temperature-signal when the temperature-signal drops below a temperature-threshold, the solenoid being responsive to open when the solenoid receives the flow-signal from the electronic-circuit; step two 502, coupling the inlet with a conduit; step three 503, coupling the electronic-circuit to a power source; step four 504, generating the temperature signal via the thermal-sensor; step five 505, transmitting the temperature-signal to the electronic-circuit; step six 506, converting the temperature-signal to a flow-signal when the temperature-signal drops below a temperature-threshold; step seven 507, transmitting the flow-signal to the solenoid; step eight 508, activating the solenoid to open the flow-valve, thereby enabling a flow of fluid through the drain-outlet; and step nine 509, coupling the hose-outlet to a garden hose.

It should be noted that step 509 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for preventing pipes from freezing, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A flow-regulating device able to automatically prevent freezing of water within conduits, the flow-regulating device comprising:
a water-tight manifold having
a hose-outlet comprising a threaded-adapter,
a drain-outlet, and
an inlet in fluid communication with at least the hose-outlet, the inlet able to be fluidly connected with a conduit;
a normally-closed flow-valve which, when not closed, enables fluid communication between the inlet and the drain-outlet;
a solenoid able to open the flow-valve when engaged;
a thermal-sensor able to produce a temperature-signal corresponding to an exterior-temperature; and
an electronic-circuit able to accept power from a power-source, receive the temperature-signal from the thermal-sensor, and produce a flow-signal based upon the temperature-signal when the temperature-signal drops below a temperature-threshold, the solenoid being responsive to open when the solenoid receives the flow-signal from the electronic-circuit.

2. The flow-regulating device of claim 1, further comprising a temperature-display screen indicating a temperature as determined by the thermal-sensor.

3. The flow-regulating device of claim 1, further comprising a manual-override button in electrical communication with a power source and the solenoid, such that engaging the manual-override button engages the solenoid and opens the normally-closed flow-valve.

4. The flow-regulating device of claim 1, further comprising a transformer-adapter which accepts an input from the power-source and provide a twelve-volt power signal output to the flow-regulating device.

5. The flow-regulating device of claim 1, wherein the transformer-adapter comprises a power-input, the power-input being selected from the group comprising a NEMA-1 standard plug and a NEMA-5 standard plug.

6. The flow-regulating device of claim 1, wherein the temperature-threshold is between thirty-one and thirty-three degrees Fahrenheit.

7. The flow-regulating device of claim 1, wherein the threaded adapter is a ¾ inch-11.5 garden hose thread.

8. The flow-regulating device of claim 1, wherein the temperature-threshold is user-programmable via a user-interface, the user-interface being in digital communication with the electronic-circuit.

9. The flow-regulating device of claim 1, wherein the inlet is always in fluid communication with the hose-outlet.

10. The flow-regulating device of claim 1, wherein the water-tight manifold is constructed of cast iron.

11. The flow-regulating device of claim 1, wherein the watertight-manifold is constructed of plastic.

12. The flow-regulating device of claim 8, wherein the user-interface comprises an L.E.D. screen.

13. The flow-regulating device of claim 2, wherein the temperature-display screen comprises an L.E.D. screen.

14. The flow-regulating device of claim 1, wherein each of the inlet, the hose-outlet, and the drain-outlet are substantially tubular.

15. A freeze-preventing and flow-regulating device comprising:
a water-tight manifold having
a hose-outlet comprising a threaded-adapter,
a drain-outlet, and
an inlet in fluid communication with at least the hose-outlet, the inlet able to be fluidly connected with a conduit;
a normally-closed flow-valve which, when not closed, enables fluid communication between the inlet and the drain-outlet;
a solenoid able to open the flow-valve when engaged;
a thermal-sensor able to produce a temperature-signal corresponding to an exterior-temperature; and
an electronic-circuit able to accept power from a power-source, receive the temperature-signal from the thermal-sensor, and produce a flow-signal based upon the temperature-signal when the temperature-signal drops below a temperature-threshold, the solenoid being responsive to open when the solenoid receives the flow-signal from the electronic-circuit;
further comprising a temperature-display screen indicating a temperature as determined by the thermal-sensor;
further comprising a transformer-adapter which accepts an input from the power-source and provide a twelve-volt power signal output to the flow-regulating device;
wherein the transformer-adapter comprises a power-input, the power-input being selected from the group comprising a NEMA-1 standard plug and a NEMA-5 standard plug;
wherein the temperature-threshold is between thirty-one and thirty-three degrees Fahrenheit;
wherein the threaded adapter is a ¾ inch-11.5 garden hose thread;
wherein the temperature-threshold is user-programmable via a user-interface, the user-interface being in digital communication with the electronic-circuit; and
wherein the inlet is always in fluid communication with the hose-outlet.

16. The flow-regulating device of claim 15, further comprising set of instructions; and
wherein the flow-regulating device is arranged as a kit.

17. A method of preventing a water conduit from freezing in cold temperatures, the method comprising the steps of:
providing a flow-regulating device able to automatically prevent freezing of water within conduits, the flow-regulating device comprising a water-tight manifold having a hose-outlet comprising a threaded-adapter, a drain-outlet, and an inlet in fluid communication with at least the hose-outlet, the inlet able to be fluidly connected with a conduit; a normally-closed flow-valve which, when not closed, enables fluid communication between the inlet and the drain-outlet, a solenoid able to open the flow-valve when engaged, a thermal-sensor able to produce a temperature-signal corresponding to an exterior-temperature, an electronic-circuit able to accept power from a power-source, receive the temperature-signal from the thermal-sensor, and produce a flow-signal based upon the temperature-signal when the temperature-signal drops below a temperature-threshold, the solenoid being responsive to open when the solenoid receives the flow-signal from the electronic-circuit;
coupling the inlet with a conduit;
coupling the electronic-circuit to a power source;
generating the temperature signal via the thermal-sensor;
transmitting the temperature-signal to the electronic-circuit;
converting the temperature-signal to a flow-signal when the temperature-signal drops below a temperature-threshold;
transmitting the flow-signal to the solenoid; and
activating the solenoid to open the flow-valve, thereby enabling a flow of fluid through the drain-outlet.

18. The method of claim 17, further comprising the steps of
coupling the hose-outlet to a garden hose.
